(19) United States
(12) Patent Application Publication
(10) Pub. No.: US 2013/0340857 A1
(43) Pub. Date: Dec. 26, 2013

(54) Protection Device for a Valve Positioner

(71) Applicants: Kevin W. Crochet, SR., Baton Rouge, LA (US); Norman Eger, Baton Rouge, LA (US); Sidney A. Rovira, III, St. Amant, LA (US)

(72) Inventors: Kevin W. Crochet, SR., Baton Rouge, LA (US); Norman Eger, Baton Rouge, LA (US); Sidney A. Rovira, III, St. Amant, LA (US)

(73) Assignee: AEGIS FLOW TECHNOLOGIES, L.L.C., Geismar, LA (US)

(21) Appl. No.: 13/527,831

(22) Filed: Jun. 20, 2012

(51) Int. Cl. F16P 1/00; B23P 17/04

(52) U.S. Cl. 137/377; 29/428

(57) ABSTRACT

An improved and more robust protection device capable of protecting a valve positioner in demanding environmental and operating conditions while also allowing for maintenance and inspection of the positioner without removing it from service. The protection device includes a housing configured to protect the valve positioner from external corrosion. The housing includes a top base, a bottom base and a central body extending between the top base and the bottom base. The central body may be joined to an edge of the top base and an edge of the bottom base thereby forming a perimeter circumscribing the top base and the bottom base.

### CROSS-REFERENCE TO RELATED APPLICATION

Not Applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present disclosure relates to protection devices for a valve element, in particular an enclosure or housing for protecting a valve positioner or position indicator in a demanding operating environment.

2. Description of Related Art

Valve positioners and position indicators are often used in control valve applications to control the open/closed position of a valve in response to an input signal. The valve positioner automatically adjusts its output to the actuator to maintain the desired position in proportion to the input signal. Valve positioners are usually mechanically connected to the valve stem or actuator and typically are available in three configurations: pneumatic positioners, analog I/P and digital controller.

Positioners allow for precise positioning accuracy and faster response to process upsets. With the increasing emphasis in the industry on economic performance of process control, positioners are usually considered for every valve application where process optimization is important. Thus, a properly functioning valve positioner is a vital element for ensuring cost-effective process operation and stability.

A common problem faced in the industry is corrosion of the positioner, gauges and the fasteners as a result of operating in very demanding environments, e.g. outdoors in weather, extreme temperature and/or corrosive environments. In these environments, especially in atmospheres containing corrosive substances such as salts and chemicals (e.g. caustic), positioners often become damaged, which can lead to diminished positioner performance, maintenance/repair and complete failure. This is often time consuming and expensive.

One solution that has been proposed is constructing positioners from corrosion resistant materials such as stainless steel. However, although the corrosion resistant materials provide an added measure of protection in demanding operating environments, the valve positioner and its ports can still become damaged over time requiring the positioner to be completely removed from service for repair or replacement.

Accordingly, in light of the foregoing, a need exists for an improved and more robust protection device capable of protecting a valve positioner in demanding environmental and operating conditions while also allowing for maintenance and inspection of the positioner without removing it from service.

### BRIEF SUMMARY OF THE INVENTION

An object of this invention is to provide an improved and more robust protection device capable of protecting a valve positioner in demanding environmental and operating conditions. Another object of this invention is to provide a protection device that allows for maintenance and inspection of a valve positioner without removing the positioner from service. Additional objects and advantages of this invention shall become apparent in the ensuing descriptions of the invention.

Accordingly, an improved and more robust protection device and method of using a protection device with a valve positioner are provided that are capable of protecting a valve positioner in demanding environmental and operating conditions while also allowing for maintenance and inspection of the positioner without removing it from service. The protection device includes a housing configured to protect the valve positioner from external corrosion. The housing includes a top base, a bottom base and a central body extending between the top base and the bottom base. The central body may be joined to an edge of the top base and an edge of the bottom base thereby forming a perimeter circumscribing the top base and the bottom base. The housing is preferably configured is configured to allow the atmosphere inside the housing to be purged and replaced. In an embodiment, the housing may also be at least partially constructed from a substantially transparent thermoplastic material to allow for inspection of the valve positioner without removing the housing.

The foregoing brief summary of the invention presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented below.

Additionally, the foregoing has outlined rather broadly the features and technical advantages of the present invention in order that the detailed description of the invention that follows may be understood. Additional features and advantages of the invention will be described hereinafter, which form the subject of the claims of the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features, which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE SEVERAL VIEWS OF THE DRAWINGS

The accompanying drawings illustrate various embodiments of this invention. However, it is to be understood that these embodiments are not intended to be exhaustive, nor limiting of the invention. These embodiments are but examples of some of the forms in which the invention may be practiced.

FIG. 1 illustrates a perspective view of an embodiment of a protection device in accordance with this invention housing a valve protector.

FIG. 2 illustrates the embodiment of the protection device shown in FIG. 1 with the top half of the protection device removed from the bottom base.

FIG. 3 illustrates a front view of the embodiment of the protection device shown in FIG. 1.

FIG. 4 illustrates a side view of the embodiment of the protection device shown in FIG. 1.

FIG. 5 illustrates cross-sectional view of the embodiment of the valve shown in FIG. 4.

FIG. 6 illustrates a top view of the embodiment of the protection device shown in FIG. 1.

FIG. 7 illustrates an embodiment of the protection device.

FIG. 8 illustrates another embodiment of the protection device wherein support members are configured to secure the central body to the top base and the bottom base.

FIG. 9 illustrates the planar wall with grooves of the embodiment of the protection device shown in FIG. 7.

FIG. 10 illustrates a top view of the planar wall with grooves shown in FIG. 8.

### DETAILED DESCRIPTION OF THE INVENTION

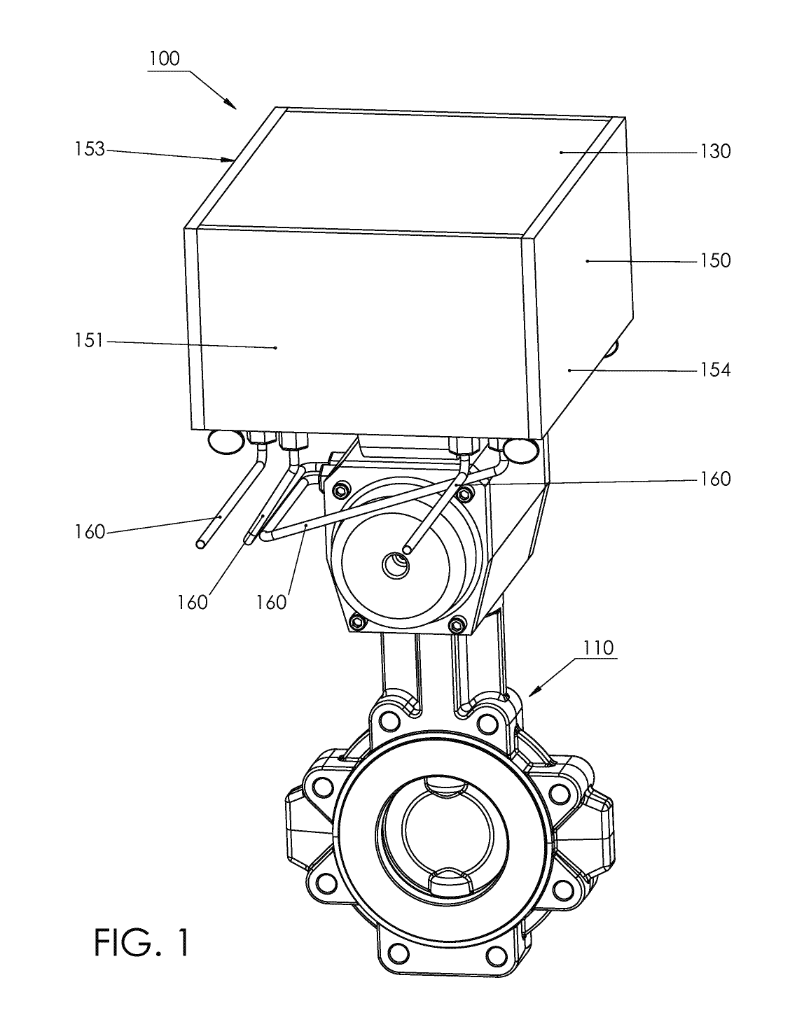

The claimed subject matter is now described with reference to the drawings, wherein like reference numerals are used to refer to like elements throughout. An embodiment of a protection device for a valve positioner in accordance with this invention is shown generally in FIG. 1 at 100.

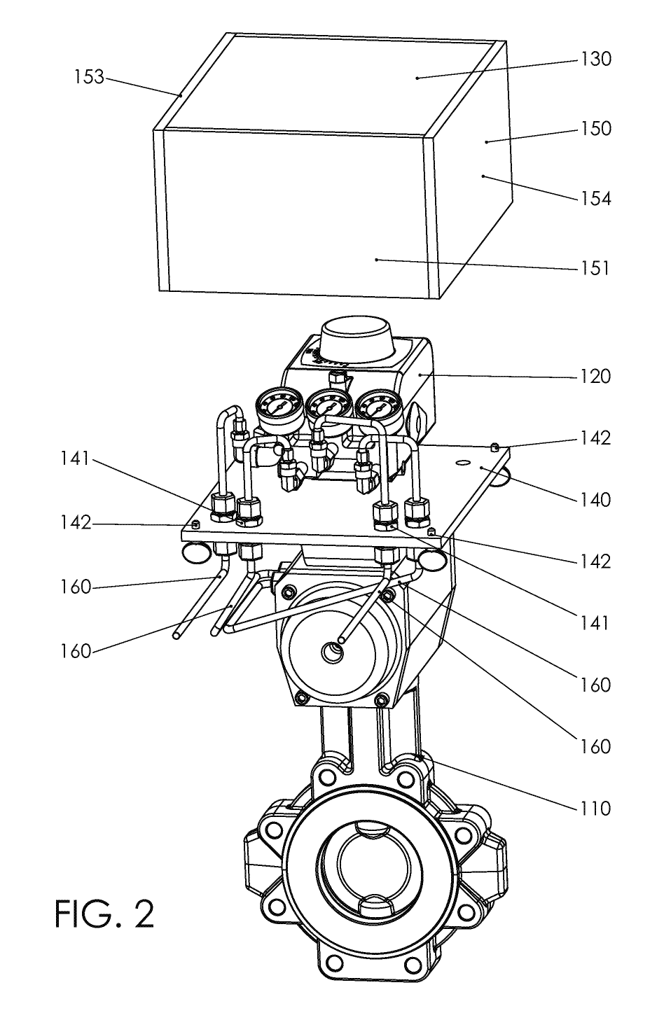

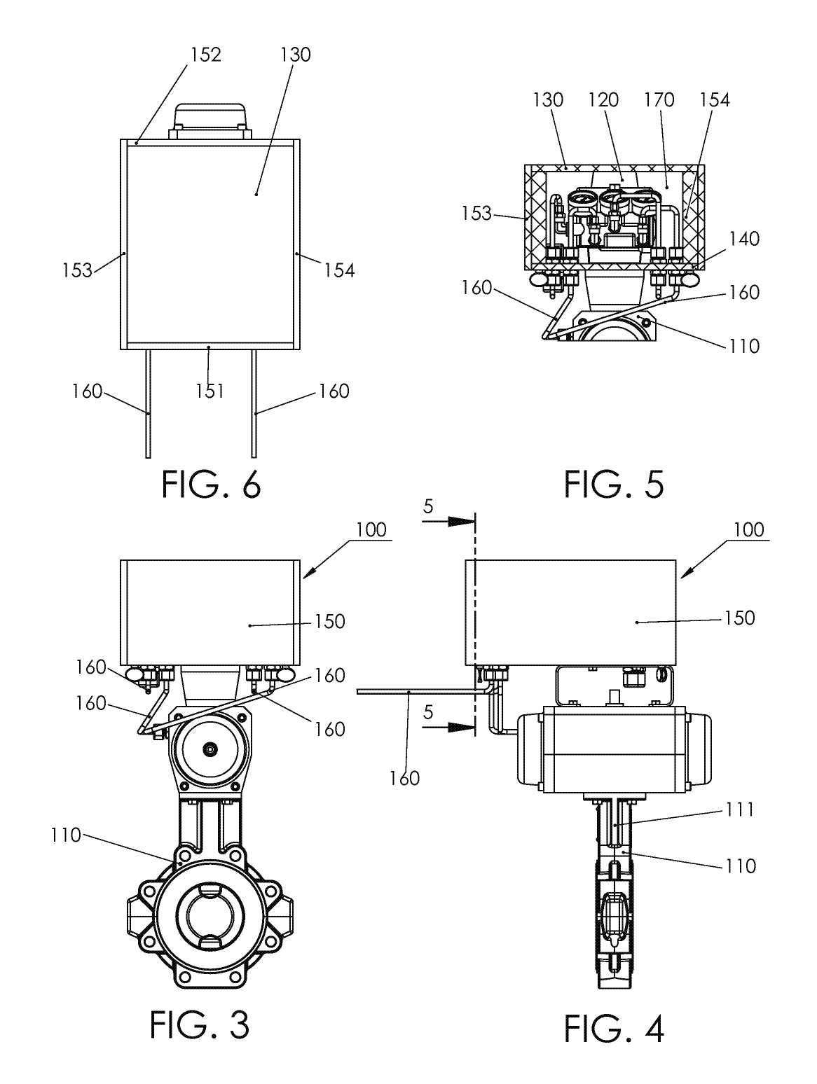

With reference initially to FIGS. 1-6, the protection device (100) comprises a housing configured to substantially protect a valve positioner (120) from external corrosion. As shown in FIG. 5, when the housing is in place around said valve positioner, a void is defined between the housing and the valve positioner (120). The protection device (100) may be secured to the valve (110), preferably secured to the valve actuator (111) or yoke. The housing comprises a top base (130), a bottom base (140), and a central body (150) that extends between the top base (130) and the bottom base (140). The central body (150) is joined to the top base and the bottom base to form a perimeter that circumscribes the top base (130) and the bottom base (140) to define a hollow enclosure. The central body (150) may comprise one or more sides and join to the edge of the top base and the edge of the bottom base.

The housing is also configured to provide enough clearance to allow one or more component connections (160) to be made to the valve positioner (120). As one of ordinary skill in the art appreciates, the configuration of the housing and the number of sides of the central body (150) will depend on the configuration and clearance requirements of the valve positioner (120) as well as other considerations such as valve accessibility. The housing also includes one or more apertures or ports (141) configured to allow the components (160) to be connected to the valve positioner (120). The interface between the port (141) and component connection (160) is preferably sealed to prevent external corrosion. Examples of components include, but are not limited to, gauges, tubing, pneumatic connections, electrical connections, data cables, and so forth.

The housing is constructed from a material configured to protect the valve positioner (120) from the effects of external corrosion. The housing can be manufactured from any corrosion resistant plastic or metal sheet. An example of a suitable plastic material includes, but is not limited to, a thermoplastic material such as rigid polyvinyl chloride material. The housing may also be at least partially constructed from a substantially transparent thermoplastic material to allow for inspection of the valve positioner without removing the housing. Examples of substantially transparent thermoplastic materials include polycarbonate resin thermoplastic materials such as poly(methyl methacrylate) (PMMA), polycarbonate resin, and so forth. The housing may be formed by any conventional molding method such as injection molding, compression molding, and so forth. Alternatively, the housing may be machined.

The protection device (100) is not only configured to protect the valve positioner (120) from the effects of external corrosion, but it is also configured to allow the atmosphere inside the housing (170) to be purged and replaced as desired. In a preferred embodiment, the atmosphere inside the housing (170) is replaced and purged using the plant air that is emitted from the valve positioner (120) as a result of the actuation of the valve. The plant air pushes the atmosphere inside the housing (170) through one or more apertures or vents provided to the housing thereby replacing it with fresh plant air, which prevents the buildup of any corrosion causing elements within the atmosphere inside the protection device (100). The one or more apertures or vents are sized to prevent the housing from over-pressurizing. In a preferred embodiment, bottom base (140) has one or more apertures or vents drilled in it.

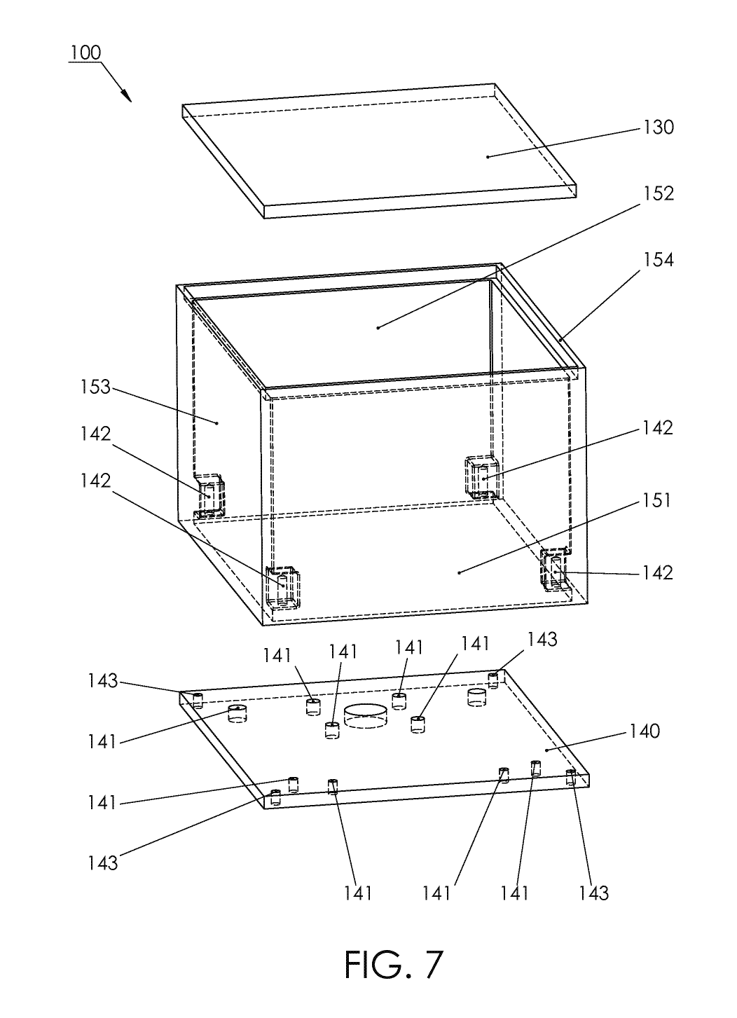

In one preferred embodiment as shown in FIG. 7, the central body (150) is releasably secured to the bottom base (140). The central body (150) and top base (130) can comprise a top potion of the protection device. The top portion may be removed from the bottom base (140) to allow easy access to the valve positioner (120). The central body may comprise a plurality of planer walls (151, 152, 153, 154). The planar walls (151, 152, 153, 154) may include a front side (151), back side (152), and two side panels (153, 154). The central body (150) may be releasably secured to the bottom base (140) and/or top base (150) by any conventional connection means (142) including, but not limited to, screws such as thumb/hand screws, nuts and bolts, posts, and so forth. The conventional connection means (142) may be secured to a corresponding aperture provided on the bottom base (143).

Alternatively, the central body (150) may be secured to the bottom base (140) and/or top base (150) by a bonding agent such as glue configured to secure thermoplastic materials to one another. The bottom base (140) and central body (150) are preferably constructed from rigid polyvinyl chloride material, and the top base (130) is constructed from a substantially transparent thermoplastic material. However, as one of ordinary skill in the art appreciates, depending on the accessibility of the valve positioner (120) for inspection, other portions of the housing (e.g. the bottom base and/or central body) may be partially or entirely constructed from a substantially transparent thermoplastic material such as poly(methyl methacrylate) (PMMA), polycarbonate resin, and so forth.

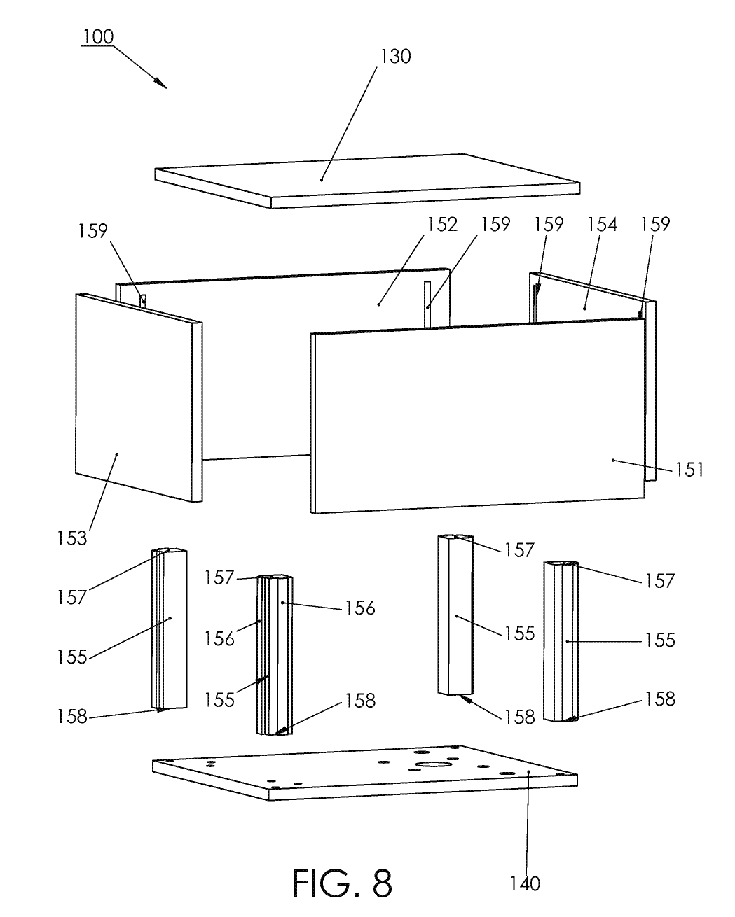

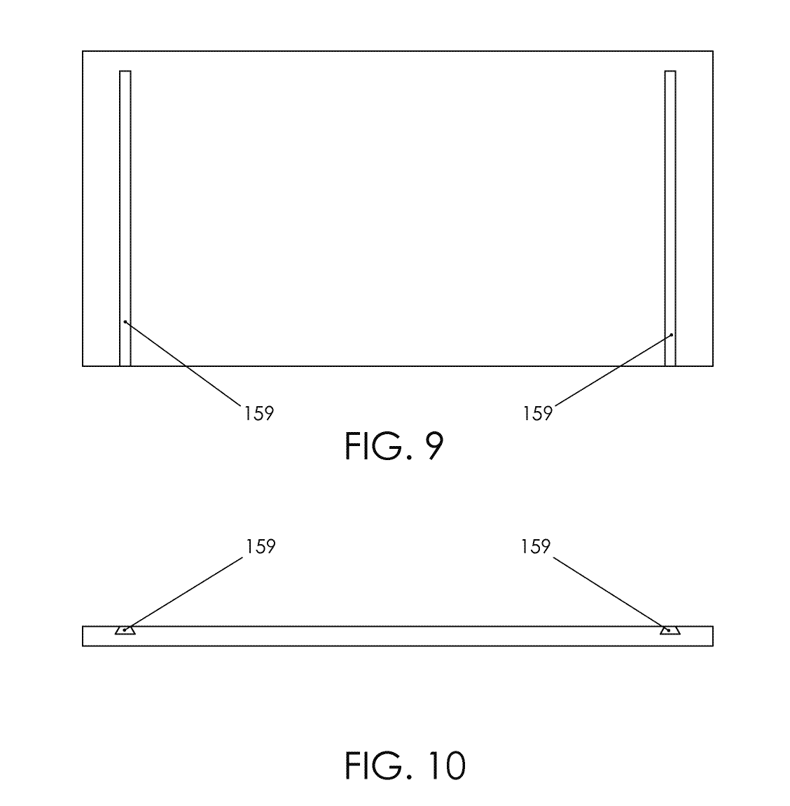

In another preferred embodiment as shown in FIGS. 8-10, a plurality of support members or posts (155) can be configured to secure the central body (150) to the top base (130) and the bottom base (140). Each support member (155) has a first end (157) and a second end (158) and is longer than it is wide. The central body (150) can be releasably secured to the bottom base (150). The central body (150) may comprise a plurality of planar walls (151, 152, 153, 154). The planar walls (151, 152, 153, 154) are joined together by the support members (155) to form perimeter circumscribing the bottom base (140) and the top base (130) thereby forming a hollow polyhedron enclosure. The support members (155) may be secured to the bottom base by any conventional connection means including, but not limited to, a threaded connection that is configured to connect to a corresponding connection on the bottom base (140). Each support member (155) preferably has a dovetail protrusion (156) that is configured to slideably connect to a corresponding groove (159) provided on each planar wall thereby securing the planar walls (151, 152, 153, 154) together. The dovetail protrusion longitudinally traverses the support member (155) between its first end (157) and second end (158). The corresponding groove (159) is preferably located on or near the periphery of each panel where it joins to another panel.

As discussed above, the housing may be constructed from a material configured to protect the valve positioner (120) from the effects of external corrosion. The support members (155) may be also constructed from a similar material, e.g. a thermoplastic such as rigid polyvinyl chloride. The housing may also be at least partially constructed from a substantially transparent thermoplastic material to allow for inspection of the valve positioner (120) without removing the housing. Examples of substantially transparent thermoplastic materials include polycarbonate resin thermoplastic materials such as poly(methyl methacrylate) (PMMA), polycarbonate resin, and so forth.

In operation, the protection device (100) as described above is secured in position around a valve (110) with a valve positioner (120). The protection device (100) may be secured to the valve (110), preferably secured to the valve actuator (111) or yoke. In a preferred embodiment, the bottom base (140) is secured to the valve positioner (120). Any components (e.g. pneumatic air connection, data cable, etc.) that need to be connected to the valve positioner are routed through one or more apertures or ports (141) that are configured to allow the components (160) to be connected to the valve positioner (120). The central body (150) is then releasably secured to the bottom base (140). The top base (150) is also secured to the central body (150). The top base (150), bottom base (140) and central body (150) define a hollow enclosure when secured to each other.

The atmosphere inside the housing (170) is replaced and purged using the plant air that is emitted from the valve positioner (120) as a result of the actuation of the valve. The plant air pushes the atmosphere inside the housing (170) through one or more vents provided to the housing thereby replacing it with fresh plant air. This prevents the buildup of any corrosion causing elements within the atmosphere inside the protection device (100). As discussed above, the housing may also be at least partially constructed from a substantially transparent thermoplastic material to allow for inspection of the valve positioner (120) without removing the protection device (100) surrounding the valve positioner (120). In addition, in the event the valve positioner (120) or valve (110) requires maintenance, the central body (150) and top base (130), i.e. the top portion of the protection device, may be removed from the bottom base (140) by removing any connection means that secure these elements together. Since the central body (150) is removably connected to the bottom base (140), the central body and top base (130) may be removed without removing the bottom base (140), which allows for faster and easier access to the valve positioner (120) by maintenance personnel.

Any reference to patents, documents and other writings contained herein shall not be construed as an admission as to their status with respect to being or not being prior art. Although the present invention and its advantages have been described in detail, it is understood that the array of features and embodiments taught herein may be combined and rearranged in a large number of additional combinations not directly disclosed, as will be apparent to one having ordinary skill in the art.

Moreover, it should be understood that various changes, substitutions and alterations can be made herein without departing from the spirit and scope of the invention as defined by the following claims. There are, of course, other alternate embodiments, which are obvious from the foregoing descriptions of the invention, which are intended to be included within the scope of the invention, as defined by the following claims.

What is claimed is:

1. A protection device for a valve positioner or positioner indicator comprising a housing, wherein said housing comprises:
a. a top base;
b. a bottom base; and
c. a central body extending between the top base and the bottom base, wherein the central body is joined to an edge of the top base and an edge of the bottom base thereby forming a perimeter circumscribing the top base and the bottom base, whereby a hollow enclosure is defined by the top base, the bottom base and the central body.

2. The protection device of claim 1, wherein the housing and the valve positioner define a void between the housing and valve positioner when the housing is in place around said valve positioner.

3. The protection device of claim 2, wherein said housing is configured to protect the valve positioner from the effects of external corrosion.

4. The protection device of claim 3, wherein the housing is configured to allow the atmosphere inside the housing to be purged and replaced.

5. The protection device of claim 4, wherein the central body is releasably secured to the bottom base.

6. The protection device of claim 5, wherein the housing is provided with one or more apertures configured to allow components to be connected to the valve positioner, and wherein the housing is also provided with one or more apertures sized to prevent the housing from over-pressurizing.

7. The protection device of claim 6, wherein the housing constructed from a thermoplastic material.

8. The protection device of claim 7, wherein housing is partially constructed from a substantially transparent thermoplastic material and a rigid polyvinyl chloride material.

9. The protection device of claim 8, wherein the bottom base and central body are constructed from rigid polyvinyl chloride material.

10. The protection device of claim 9, wherein the top base is constructed from a substantially transparent thermoplastic.

11. The protection device of claim 10, wherein the central body and top base comprise a top portion, wherein top portion may be removed from the bottom base to allow access to the valve positioner without removing the bottom base.

12. The protection device of claim 11, wherein the central body comprises a plurality of planar walls, wherein the planar walls are secured together to form perimeter circumscribing the bottom base and the top base thereby forming a hollow enclosure.

13. The protection device of claim 12, wherein the housing is injection molded.

14. The protection device of claim 13, wherein the central body is secured to the bottom base by a connection means.

15. The protection device of claim 12, wherein the central body is joined to the top base and the bottom base by a plurality of support members configured to secure the central body to the top base and the bottom base, wherein each support member has a first end and a second end and said support member is longer than it is wide.

16. The protection device of claim 15, wherein the each support member is secured to the bottom base by a threaded connection that is configured to connect to a corresponding connection on the bottom base.

17. The protection device of claim 16, wherein each support member has a dovetail protrusion that is configured to slideably connect to a corresponding groove provided on each planar wall thereby securing the planar walls together.

18. The protection device of claim 17, wherein the dovetail protrusion longitudinally traverses said support member between its first end and second end.

19. The protection device of claim 18, wherein the corresponding groove is located on or near the periphery of each panel where it joins to another panel.

20. A method for protecting a valve positioner or positioner indicator comprising:
a. Securing a protection device in position around valve positioner, wherein the protection device comprises a housing configured to protect the valve positioner from external corrosion, wherein said housing comprises:
i. a top base;
ii. a bottom base; and
iii. a central body extending between the top base and the bottom base, wherein the central body is joined to an edge of the top base and an edge of the bottom base thereby forming a perimeter circumscribing the top base and the bottom base, whereby a hollow enclosure is defined by the top base, the bottom base and the central body.
b. replacing and purging the atmosphere inside the housing with fresh plant air.
